(19) United States
(12) Patent Application Publication
(10) Pub. No.: US 2025/0262657 A1
(43) Pub. Date: Aug. 21, 2025

(54) COIL LIFTERS

(71) Applicants: SDNS, Inc., Lake Forest, CA (US); Seoul Laser Dieboard System Co., Ltd., Gyeonggi-do (KR)

(72) Inventor: Kyong Chan Lim, San Diego, CA (US)

(21) Appl. No.: 19/051,019

(22) Filed: Feb. 11, 2025

Related U.S. Application Data
(60) Provisional application No. 63/554,638, filed on Feb. 16, 2024.

(51) Int. Cl. B21D 43/20

(52) U.S. Cl. CPC B21D 43/20

(57) ABSTRACT

A coil lifter including: a first rack including multiple slots configured to house metallic coils of various sizes, wherein a coil of a desired size is selected from the metallic coils in the multiple slots of the first rack; and a second rack coupled to the first rack and a bending machine for bending rules or profiles, the second rack including at least one movable slot to transfer the selected coil from the first rack to the at least one movable slot of the second rack, wherein an unspooled end of the selected coil is fed into the bending machine once the at least one movable slot of the second rack is appropriately positioned with respect to the bending machine.

### CROSS-REFERENCE TO RELATED APPLICATIONS

This application claims the benefit of priority under 35 U.S.C. § 119 (e) of co-pending U.S. Provisional Patent Application No. 63/554, 638, filed Feb. 16, 2024, entitled “Coil Lifters.” The disclosure of the above-referenced application is incorporated herein by reference.

### BACKGROUND

### Field of the Disclosure

The present disclosure relates to machines for bending rules or profiles, and more specifically, to a coil lifter coupled to a bending machine.

### Background

A strip of rule or profile is used to form a channel letter or cutting blade pattern by bending the rule or profile using a bending machine. In one example, the profile used to form the channel letter may include at least one rib including an upper rib and a lower rib. In another example, the strip of rule used to form the cutting blade pattern is attached to a die-board for use in pressing a folding or a cutting line on plate matters such as paper, canvas, leather, plastic, etc.

The strip of rule or profile fed into the bending machine may be generally prepared in a large roll. However, the large roll of metallic material may be extremely heavy (e.g., heavier than what a person of an average weight can lift), where a single large roll needs to provide long enough material to produce multiple channel letters or cutting blade patterns. Therefore, multiple operators or heavy machineries are needed to lift the roll up onto a feeding table for feeding the roll into the bending machine. Accordingly, a need exists for easier means for an operator of the bending machine to lift and feed the roll of metallic material into the bending machine.

### SUMMARY

The present disclosure discloses a coil lifter coupled to a bending machine.

In one implementation, a coil lifter is disclosed. The coil lifter includes: a first rack including multiple slots configured to house metallic coils of various sizes, wherein a coil of a desired size is selected from the metallic coils in the multiple slots of the first rack; and a second rack coupled to the first rack and a bending machine for bending rules or profiles, the second rack including at least one movable slot to transfer the selected coil from the first rack to the at least one movable slot of the second rack, wherein an unspooled end of the selected coil is fed into the bending machine once the at least one movable slot of the second rack is appropriately positioned with respect to the bending machine.

In another implementation, a coil lifter is disclosed. The coil lifter includes: a first rack including multiple slots configured to house metallic coils of various sizes; and a second rack coupled to the first rack, the second rack including at least one movable slot to receive a metallic coil loaded onto the at least one movable slot, wherein the loaded metallic coil is transferred to a selected slot of the multiple slots using at least one sliding plate to move the loaded metallic coil to the second rack.

### BRIEF DESCRIPTION OF THE DRAWINGS

FIG. 1 shows one example of a coil lifter coupled to a bending machine in accordance with one implementation of the present disclosure;

FIG. 2 shows a side view of the coil lifter in accordance with one implementation of the present disclosure;

FIG. 3 shows a closeup side view of the slider in accordance with one implementation of the present disclosure;

FIGS. 4A through 4D show a process of loading coils onto the slots of a first rack of a coil lifter in accordance with one implementation of the present disclosure;

FIGS. 5A through 5C show a process of unloading a coil from a selected slot of a first rack of a coil lifter and feeding the coil into a bending machine in accordance with one implementation of the present disclosure;

FIG. 6A is a top view of a coil lifter coupled to a bending machine in accordance with one implementation of the present disclosure; and

FIG. 6B is a top view of the coil lifter coupled to the bending machine in accordance with another implementation of the present disclosure.

### DETAILED DESCRIPTION

As described above, the strip of rule or profile fed into the bending machine may be generally prepared in a large roll. However, the large roll of metallic material may be extremely heavy, and multiple operators or heavy machineries are needed to lift the roll up onto a feeding table for feeding the roll into the bending machine. Accordingly, a need exists for easier means for an operator of the bending machine to lift and feed the roll of metallic material into the bending machine.

Certain implementations of the present disclosure provide for a coil lifter which provides an easier means to move and load the large coil of metallic material. After reading the below descriptions, it will become apparent how to implement the disclosure in various implementations and applications. Although various implementations of the present disclosure will be described herein, it is understood that these implementations are presented by way of example only, and not limitation. As such, the detailed description of various implementations should not be construed to limit the scope or breadth of the present disclosure.

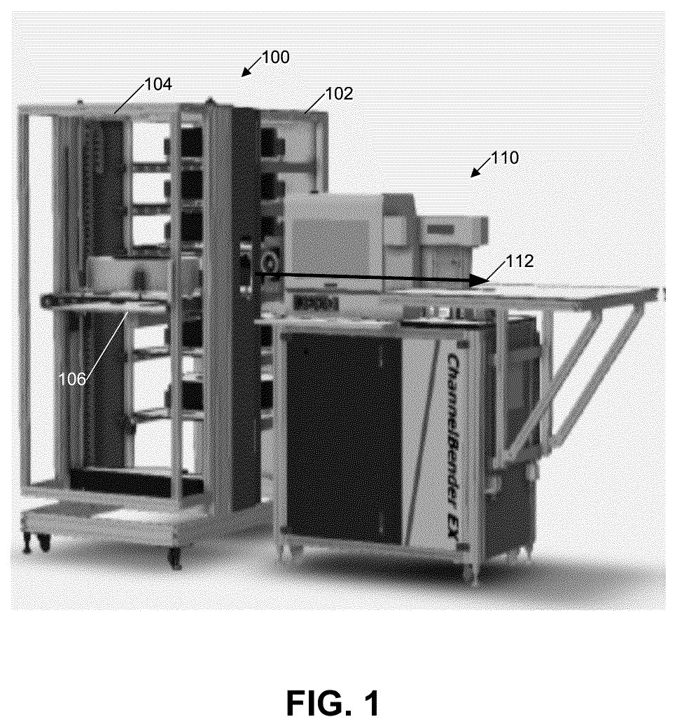

FIG. 1 shows one example of a coil lifter 100 coupled to a bending machine 110 in accordance with one implementation of the present disclosure. In one implementation, the coil lifter 100 includes a rack 102 with multiple slots pre-filled with coils of various sizes, where a coil (which fits the coupled bending machine 110) is selected from the coils in the multiple slots.

In the illustrated implementation of FIG. 1, the coil lifter 100 includes at least two attached racks 102, 104, wherein a first rack 102 includes multiple slots to house coils/rolls of multiple different sizes in a vertical configuration. In one implementation, a particular coil is selected from the multiple slots of the first rack 102 and is transferred over to a second rack 104 with a vertically movable slot 106. In other implementations, a first rack includes multiple slots arranged in a horizontal configuration and a second rack is arranged with a horizontally movable slot.

In one implementation, once the movable slot 106 of the second rack 104 is appropriately positioned (e.g., in a longitudinal axis 112 with a feeding axis of the bending machine), the selected coil (of rule or profile) is fed into the bending machine 110.

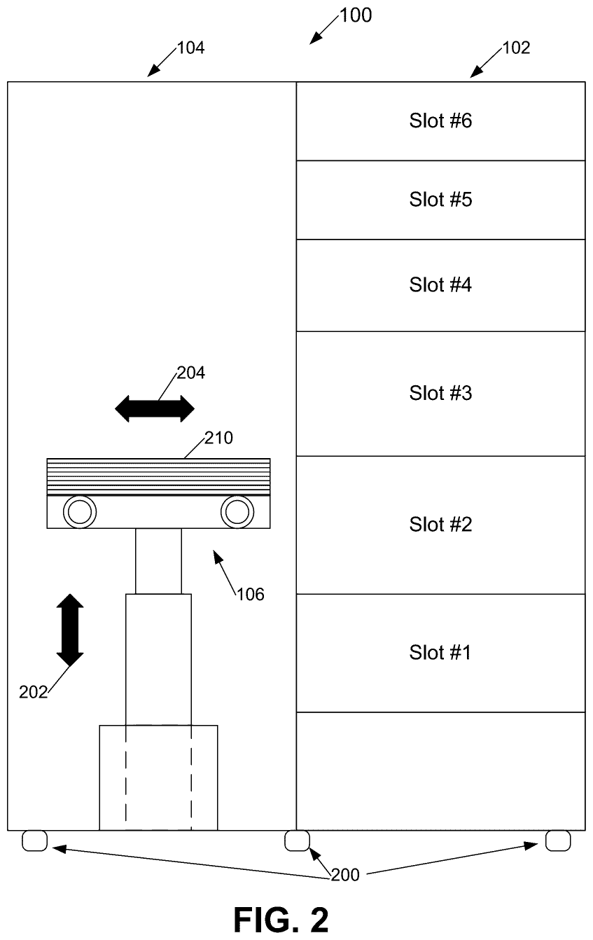

FIG. 2 shows a side view of the coil lifter 100 in accordance with one implementation of the present disclosure. In the illustrated implementation of FIG. 2, the coil lifter 100 includes two racks 102, 104. As described above, the first rack 102 includes multiple slots (e.g., slot #1 through slot #6), while the second rack 104 includes a movable slot 106 which can be moved vertically to receive and load coils of different sizes into the multiple slots of the first rack 102. In one implementation, the coil lifter 100 includes a plurality of wheels 200 for ease of transportation of the coil lifter 100.

In one implementation, the movable slot 106 of the second rack 104 is moved up and down in a vertical direction 202. Further, the movable slot 106 also includes at least one slider 210 to slide the coil (e.g., received coil or selected coil) into and out of the slots in the first rack 102 in a horizontal direction 204.

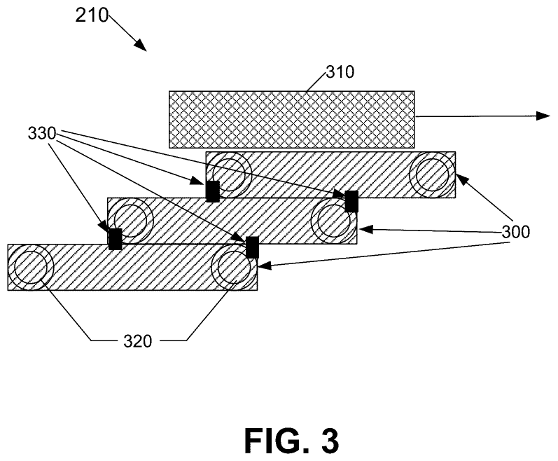

FIG. 3 shows a closeup side view of the slider 210 in accordance with one implementation of the present disclosure. In the illustrated implementation of FIG. 3, the slider 210 includes at least one sliding plate 300 (preferably two or more) used to transfer the received coil 310 onto a slot in one of the multiple slots in the first rack 102. In one implementation, each plate of the at least one sliding plate 300 includes at least one sliding wheel 320, which enables each plate to slide on top of each other. In another implementation, each plate of the least one sliding plate 300 includes a mechanism or stopper (e.g., 330) to prevent other plate(s) contacting each plate from sliding out of contact. The received coil 310 is placed on a top plate of the at least one sliding plate 300.

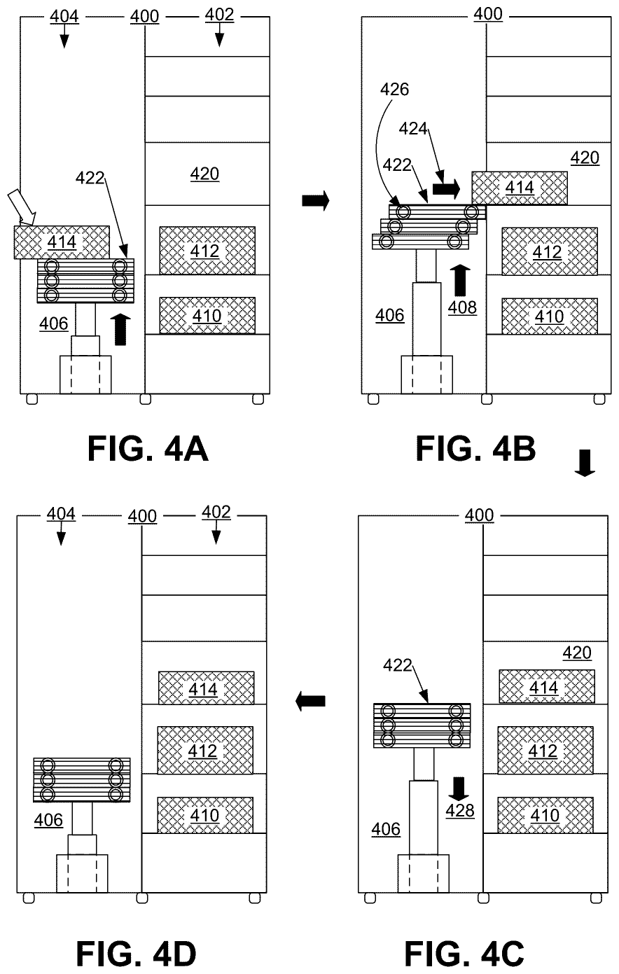

FIGS. 4A through 4D show a process of loading the coils 410, 412, 414 onto the slots of a first rack 402 of a coil lifter 400 in accordance with one implementation of the present disclosure.

FIG. 4A shows the coils 410, 412 already loaded onto the slots of the first rack 402, while the coil 414 is received on a movable slot 406 of a second rack 404. In one implementation, the coil 414 is placed onto the movable slot 406 by various means such as a forklift. Once the coil 414 is placed on the movable slot 406, the slot 406 (which includes a slider 422) is vertically moved up to place the coil 414 onto a selected slot (e.g., slot 420).

FIG. 4B shows the coil 414 being placed on the selected slot 420 by moving the slot 406 vertically up (as shown by arrow 408) so that top of a slider 422 is flush with the bottom surface of the slot 420. Once the top of the slider 422 is flush with the bottom surface of the slot 420, the coil 414 is moved horizontally (as shown by arrow 424) onto the selected slot 420. In one implementation, the coil 414 is moved onto the selected slot 420 by moving the rollers 426 of the slider 422 clockwise. In another implementation, the coil 414 is pushed into the selected slot 420 using a pushing means (e.g., a hydraulic pump) with the rollers 426 moving due to the push force of the coil 414.

FIG. 4C shows the coil 414 placed on the selected slot 420 with the rollers 422 retracted and the movable slot 406 prepared to be moved vertically (as shown by arrow 428).

FIG. 4D shows the coils 410, 412, 414 placed on the slots of the first rack 402 and the movable slot 406 of the second rack 404 ready to receive additional coils.

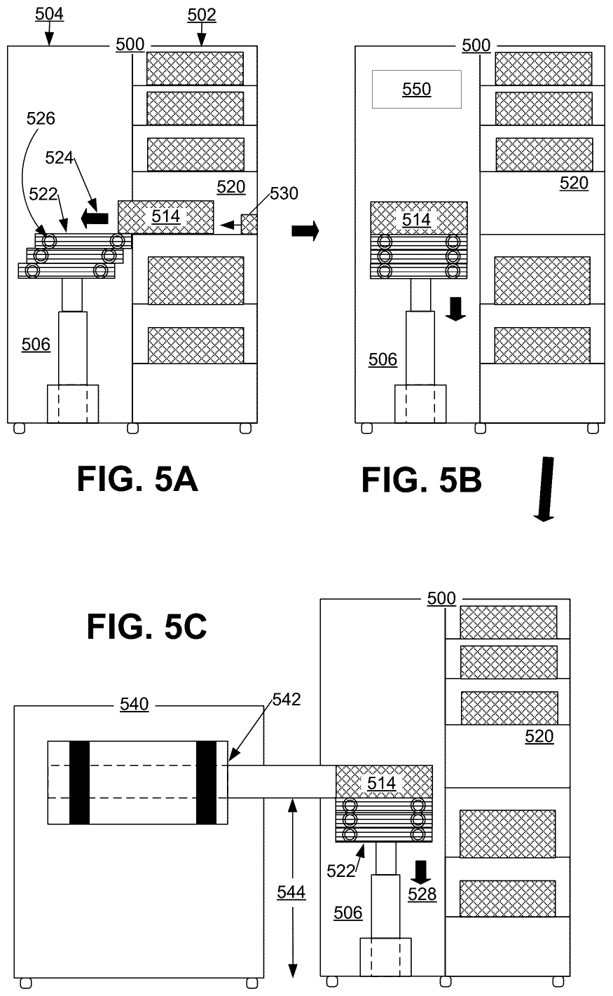

FIGS. 5A through 5C show a process of unloading a coil 514 from a selected slot (e.g., slot 520) of a first rack 502 of a coil lifter 500 and feeding the coil 514 into a bending machine in accordance with one implementation of the present disclosure.

FIG. 5A shows the coil 514 being moved horizontally (as shown by arrow 524) out of the selected slot 520 and onto a slider 522 of a movable slot 506 so that the coil 514 can be placed in a proper position to be fed into a bending machine. In one implementation, the coil 514 is moved onto the slider 522 of the movable slot 506 by moving the rollers 526 of the slider 522 counter-clockwise. In some implementations, the coil 514 is also initially pushed onto the slider 522 of the movable slot 506 using a pushing means (e.g., an electronically-controlled spring 530).

FIG. 5B shows the coil 514 placed on the slider 522 of the movable slot 506 after being moved out of the selected slot 520. Once the coil 514 is placed on the slider 522, plates of the slider 522 are retracted and the movable slot 506 is prepared for a vertical movement.

FIG. 5C shows the movable slot 506 being moved down 528 (or up) to properly position the coil 514 so that when the coil 514 is unspooled, the unspooled end of the coil 514 correctly inserts and fits into bending mechanisms 542 (e.g., bending fingers, pullers, etc.) of the bending machine 540. In one implementation, the coil lifter 500 also includes a processor and a memory 550 for calculating and storing the position (e.g., vertical height 544) of the movable slot 506 that provides correct insertion/fitting is known to the coil lifter 500.

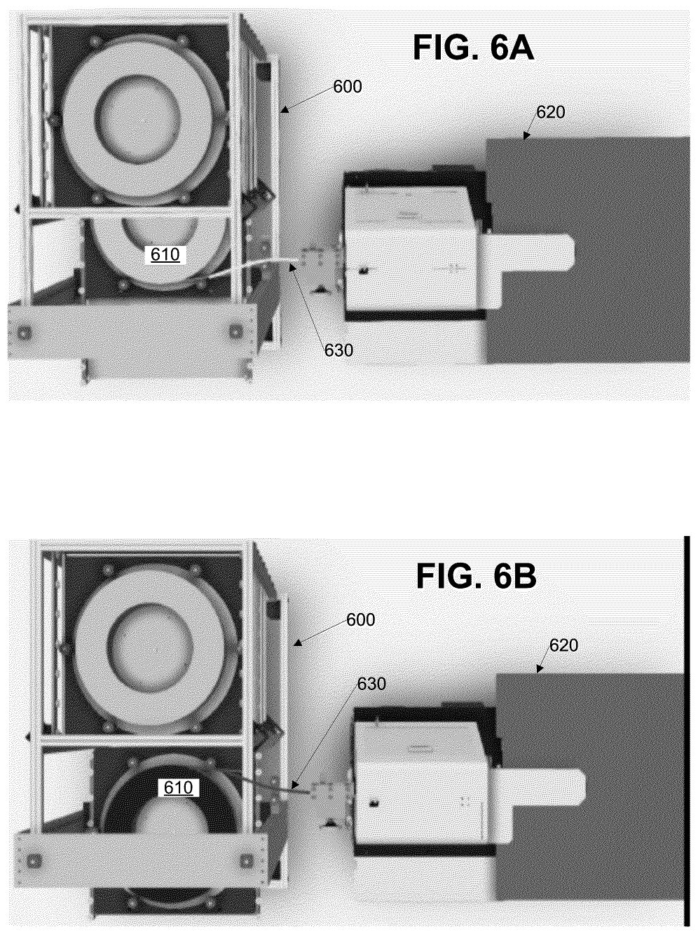

FIG. 6A is a top view of a coil lifter 600 coupled to a bending machine 620 in accordance with one implementation of the present disclosure. The illustrated implementation of FIG. 6A shows a selected coil 610 feeding an unspooled end 630 into the bending machine 620. In this implementation, the coil 610 is being unspooled in a counter-clockwise direction.

FIG. 6B is a top view of the coil lifter 600 coupled to the bending machine 620 in accordance with another implementation of the present disclosure. The illustrated implementation of FIG. 6B shows the selected coil 610 feeding the unspooled end 630 into the bending machine 620. In this implementation, the coil 610 is being unspooled in a clockwise direction.

In a particular implementation, a coil lifter is disclosed. The coil lifter includes: a first rack including multiple slots configured to house metallic coils of various sizes, wherein a coil of a desired size is selected from the metallic coils in the multiple slots of the first rack; and a second rack coupled to the first rack and a bending machine for bending rules or profiles, the second rack including at least one movable slot to transfer the selected coil from the first rack to the at least one movable slot of the second rack, wherein an unspooled end of the selected coil is fed into the bending machine once the at least one movable slot of the second rack is appropriately positioned with respect to the bending machine.

In one implementation, the multiple slots of the first rack are stacked vertically. In one implementation, the at least one movable slot of the second rack includes at least one vertically movable slot. In one implementation, the multiple slots of the first rack are arranged in a horizontal configuration and the second rack includes at least one horizontally movable slot. In one implementation, the at least one movable slot of the second rack being appropriately positioned with respect to the bending machine includes said at least one movable slot of the second rack being in a longitudinal axis with a feeding axis of the bending machine. In one implementation, the first rack and the second rack include a plurality of wheels. In one implementation, the at least one movable slot of the second rack includes at least one sliding plate to transfer the selected coil into and out of the multiple slots in the first rack. In one implementation, each plate of the at least one sliding plate includes a mechanism or stopper to prevent other plates contacting each plate from sliding out of contact. In one implementation, each plate of the at least one sliding plate includes at least one sliding wheel. In one implementation, at least one slot of the multiple slots of the first rack includes a pushing means to push the selected coil onto the at least one sliding plate of the at least one movable slot. In one implementation, the coil lifter further includes a processor and a memory to calculate and store a position of the at least one movable slot of the second rack when the at least one movable slot is appropriately positioned with respect to the bending machine.

In another implementation, a coil lifter is disclosed. The coil lifter includes: a first rack including multiple slots configured to house metallic coils of various sizes; and a second rack coupled to the first rack, the second rack including at least one movable slot to receive a metallic coil loaded onto the at least one movable slot, wherein the loaded metallic coil is transferred to a selected slot of the multiple slots using at least one sliding plate to move the loaded metallic coil to the second rack.

In one implementation, the multiple slots of the first rack are stacked vertically. In one implementation, the at least one movable slot of the second rack includes at least one vertically movable slot. In one implementation, the coil lifter further includes a hydraulic pump configured to vertically move the at least one vertically movable slot. In one implementation, the multiple slots of the first rack are arranged in a horizontal configuration and the second rack includes at least one horizontally movable slot. In one implementation, each plate of the at least one sliding plate includes a mechanism or stopper to prevent other plates contacting each plate from sliding out of contact. In one implementation, each plate of the at least one sliding plate includes at least one sliding wheel. In one implementation, the coil lifter further includes a processor to determine the selected slot from the multiple slots of the first rack to transfer the loaded metallic coil from the second rack. In one implementation, the processor calculates a position of the at least one movable slot of the second rack when the at least one movable slot is positioned to transfer the metallic coil to the selected slot.

The description herein of the disclosed implementations is provided to enable any person skilled in the art to make or use the present disclosure. Numerous modifications to these implementations would be readily apparent to those skilled in the art, and the principles defined herein may be applied to other implementations without departing from the spirit or scope of the present disclosure. Thus, the present disclosure is not intended to be limited to the implementations shown herein but is to be accorded the widest scope consistent with the principal and novel features disclosed herein. Accordingly, additional variations and implementations are also possible.

All features of each of the above-discussed examples are not necessarily required in a particular implementation of the present disclosure. Further, it is to be understood that the description and drawings presented herein are representative of the subject matter which is broadly contemplated by the present disclosure. It is further understood that the scope of the present disclosure fully encompasses other implementations that may become obvious to those skilled in the art and that the scope of the present disclosure is accordingly limited by nothing other than the appended claims.

1. A coil lifter comprising:
a first rack including multiple slots configured to house metallic coils of various sizes,
wherein a coil of a desired size is selected from the metallic coils in the multiple slots of the first rack; and
a second rack coupled to the first rack and a bending machine for bending rules or profiles,
the second rack including at least one movable slot to transfer the selected coil from the first rack to the at least one movable slot of the second rack,
wherein an unspooled end of the selected coil is fed into the bending machine once the at least one movable slot of the second rack is appropriately positioned with respect to the bending machine.

2. The coil lifer of claim 1, wherein the multiple slots of the first rack are stacked vertically.

3. The coil lifter of claim 1, wherein the at least one movable slot of the second rack includes at least one vertically movable slot.

4. The coil lifter of claim 1, wherein the multiple slots of the first rack are arranged in a horizontal configuration and the second rack includes at least one horizontally movable slot.

5. The coil lifter of claim 1, wherein the at least one movable slot of the second rack being appropriately positioned with respect to the bending machine includes
said at least one movable slot of the second rack being in a longitudinal axis with a feeding axis of the bending machine.

6. The coil lifter of claim 1, wherein the first rack and the second rack include a plurality of wheels.

7. The coil lifter of claim 1, wherein the at least one movable slot of the second rack includes
at least one sliding plate to transfer the selected coil into and out of the multiple slots in the first rack.

8. The coil lifter of claim 7, wherein each plate of the at least one sliding plate includes a mechanism or stopper to prevent other plates contacting each plate from sliding out of contact.

9. The coil lifter of claim 7, wherein each plate of the at least one sliding plate includes at least one sliding wheel.

10. The coil lifter of claim 7, wherein at least one slot of the multiple slots of the first rack includes
a pushing means to push the selected coil onto the at least one sliding plate of the at least one movable slot.

11. The coil lifter of claim 1, further comprising
a processor and a memory to calculate and store a position of the at least one movable slot of the second rack when the at least one movable slot is appropriately positioned with respect to the bending machine.

12. A coil lifter comprising:
a first rack including multiple slots configured to house metallic coils of various sizes; and
a second rack coupled to the first rack,
the second rack including at least one movable slot to receive a metallic coil loaded onto the at least one movable slot,
wherein the loaded metallic coil is transferred to a selected slot of the multiple slots using at least one sliding plate to move the loaded metallic coil to the second rack.

13. The coil lifer of claim 12, wherein the multiple slots of the first rack are stacked vertically.

14. The coil lifter of claim 12, wherein the at least one movable slot of the second rack includes at least one vertically movable slot.

15. The coil lifter of claim 14, further comprising
a hydraulic pump configured to vertically move the at least one vertically movable slot.

16. The coil lifter of claim 12, wherein the multiple slots of the first rack are arranged in a horizontal configuration and the second rack includes at least one horizontally movable slot.

17. The coil lifter of claim 12, wherein each plate of the at least one sliding plate includes a mechanism or stopper to prevent other plates contacting each plate from sliding out of contact.

18. The coil lifter of claim 12, wherein each plate of the at least one sliding plate includes at least one sliding wheel.

19. The coil lifter of claim 12, further comprising
a processor to determine the selected slot from the multiple slots of the first rack to transfer the loaded metallic coil from the second rack.

20. The coil lifter of claim 12, wherein the processor
calculates a position of the at least one movable slot of the second rack when the at least one movable slot is positioned to transfer the metallic coil to the selected slot.
